(19) United States
(12) Patent Application Publication
(10) Pub. No.: US 2008/0030127 A1
(43) Pub. Date: Feb. 7, 2008

(54) Organic light-emitting device with heat dissipation structure

(75) Inventors: Chung Che Tsou, Yangmei (TW); Shin Ju Lin, Taichung (TW)

Correspondence Address: WPAT, PC;INTELLECTUAL PROPERTY ATTORNEYS, 2030 MAIN STREET, SUITE 1300, IRVINE, CA, 92614, US

(73) Assignee: RITDISPLAY CORPORATION, HSIN CHU INDUSTRIAL PARK (TW)

(21) Appl. No.: 11/580,944

(22) Filed: Oct. 16, 2006

(30) Foreign Application Priority Data
Aug. 7, 2006 (TW) 095128815

(51) Int. Cl. H01J 1/62; H01J 63/04

(52) U.S. Cl. 313/504

(57) ABSTRACT

An organic light-emitting device (OLED) with a heat dissipation structure includes a substrate, an anode layer, a metal layer, a light-emitting layer, a cathode layer, at least one external anode, and at least one external cathode, wherein at least one external anode is connected to the anode layer, and at least one external cathode is connected to the cathode layer. The metal layer, due to having a high thermal conductivity, conducts the heat generated during the operation of the light-emitting layer to the external anode. The cathode layer, due to having a good thermal conductivity, also conducts the heat generated during the operation of the light-emitting layer to the external cathode. In addition, the tips of the metal layer after being etched may cause discontinuity of the coating layer of the light-emitting layer and abnormal light emission. Therefore, an insulating material is needed to wrap the metal layer to produce a flattening effect, thereby eliminating the discontinuity of the coating layer of the light-emitting layer.

### BACKGROUND OF THE INVENTION

1. Field of the Invention

The present invention relates to an OLED (Organic Light-Emitting Device), and more particularly to an OLED with a heat dissipation structure.

2. Description of the Related Art

FIG. 1 is a schematic cross-sectional view of a conventional organic light-emitting diode device 10. The organic light-emitting diode device 10 mainly includes a substrate 11, an anode layer 13, a light-emitting layer 15, and a cathode layer 17 successively formed on the substrate 11.

Being disposed between the anode layer 13 and the cathode layer 17, the light-emitting layer 15 of the organic light-emitting diode device 10 can emit light rays automatically after an appropriate voltage is applied to the anode layer 13 and the cathode layer 17.

When the light-emitting layer 15 continues emitting light, a part of the electric power is converted into heat energy. As the light-emitting material of the light-emitting layer 15 and the anode layer 13 of ITO both have poor thermal conducting capability, the heat is accumulated in the light-emitting layer 15, resulting in the aging of the light-emitting layer 15 and gradually lowering the brightness, and reducing the service life.

### SUMMARY OF THE INVENTION

An object of the present invention is to provide an OLED with a heat dissipation structure, which is capable of conducting the heat generated during light emission to the outside, so as to prolong the service life.

The OLED comprises a substrate, an anode layer, a metal layer, a light-emitting layer, a cathode layer, at least one external anode, and at least one external cathode, wherein at least one external anode is connected to the anode layer, and at least one external cathode is connected to the cathode layer.

The tips on the metal layer resulting from an etching process may cause the discontinuity of the coating layer of the light-emitting layer and abnormal light emission. Therefore, an insulating material is needed to wrap the metal layer to produce a flattening effect, thereby eliminating the discontinuity of the coating layer of the light-emitting layer.

The metal layer, due to having a high thermal conductivity, conducts the heat generated during the operation of the light-emitting layer to the external anode. The cathode layer made of Al, due to having a good thermal conductivity, also conducts the heat generated during the operation of the light-emitting layer to the external cathode.

In addition to natural air cooling, the external anode and external cathode can be cooled down by heat dissipation, such that the heat generated during the operation of the light-emitting layer can be quickly conducted to the outside.

The shape of the effective light-emitting area of the light-emitting layer can be a plurality of arbitrary polygons, such as a plurality of rectangles, circles, and honeycombs.

The external anode and external cathode can be one or more, and can be arranged in any shape. The design of the heat dissipation structure for the metal layer disclosed in the present invention can surely conduct the heat generated during the operation of the light-emitting layer to the outside, thereby prolonging the service life of the OLED.

### BRIEF DESCRIPTION OF THE DRAWINGS

The invention will be described according to the appended drawings in which:

FIG. 1 is a schematic cross-sectional view of a conventional organic light-emitting diode device;

FIG. 2(a) is a schematic top view of an OLED in accordance with an embodiment of the present invention;

FIG. 2(b) is a cross-sectional view of FIG. 2(a);

FIG. 2(c) is a cross-sectional view in accordance with another embodiment of the present invention;

FIGS. 3(a)-3(b) are schematic top views of OLEDs in accordance with different embodiments of the present invention; and

FIGS. 4(a)-4(e) are schematic top views of OLEDs in accordance with different embodiments of the present invention.

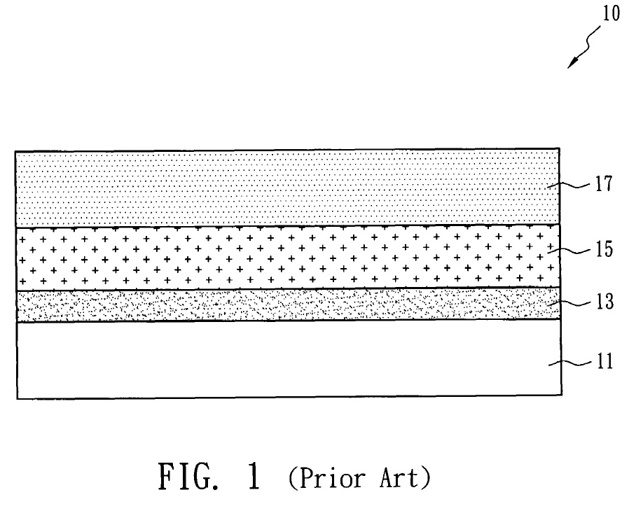

### PREFERRED EMBODIMENT OF THE PRESENT INVENTION

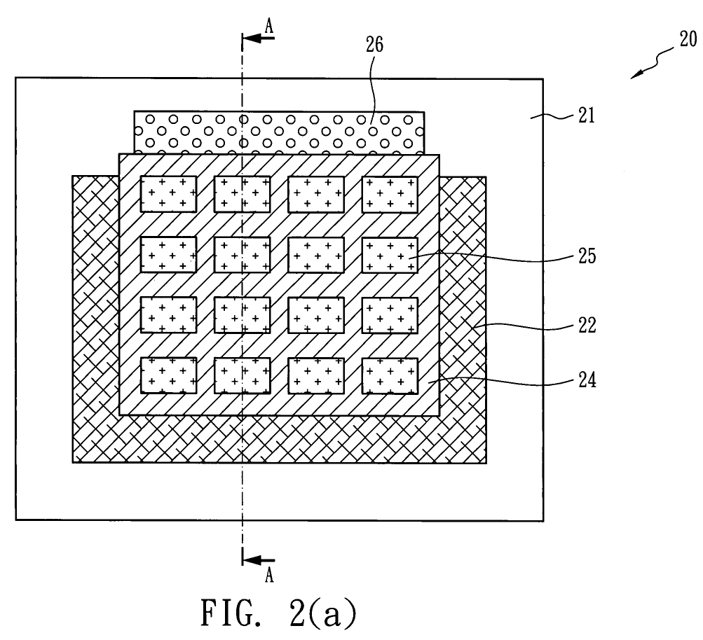

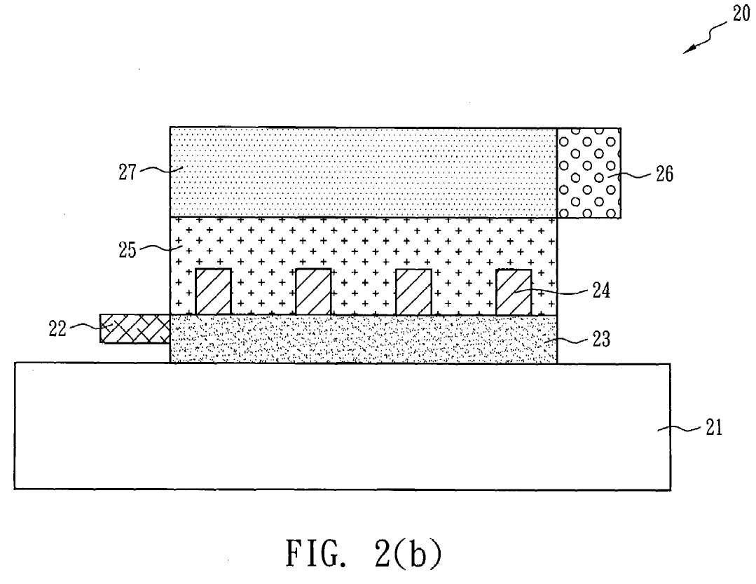

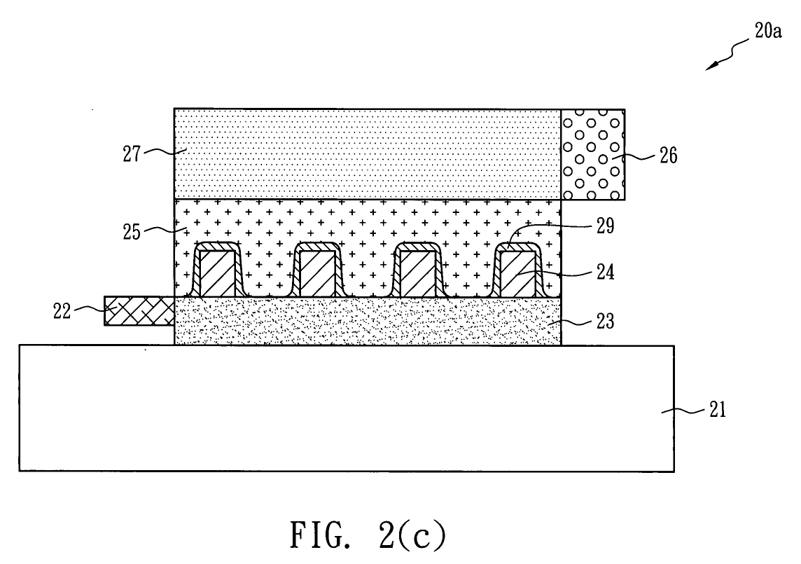

FIG. 2(a) is a schematic top view of an OLED 20 with a heat dissipation structure according to an embodiment of the present invention. FIG. 2(b) is a cross-sectional view obtained by turning the sectional view of the OLED 20 taken along the sectional line A-A in FIG. 2(a) by 180°, so the transparent substrate 21 is at the lower part of the figure. Moreover, the anode layer 23 in FIG. 2(b) is also made of a transparent material, so the anode layer 23 is not shown in FIG. 2(a).

As shown in FIG. 2(b), the OLED 20 includes a substrate 21, a transparent anode layer 23, a metal layer 24, a light-emitting layer 25, a cathode layer 27, an external anode 22, and an external cathode 26. The anode layer 23 is formed on the substrate 21. The metal layer 24 is formed on the anode layer 23. The light-emitting layer 25 is formed on the anode layer 23 and covers the metal layer 24. The cathode layer 27 is formed on the light-emitting layer 25. The external anode 22 is connected to the anode layer 23, and the external cathode 26 is connected to the cathode layer 27.

The metal layer 24, due to having a high thermal conductivity, conducts the heat generated during the operation of the light-emitting layer 25 to the external anode 22. The cathode layer 27 made of Al, due to having a good thermal conductivity, also conducts the heat generated during the operation of the light-emitting layer 25 to the external cathode 26.

In addition to natural air cooling, the external anode 22 and external cathode 26 can be cooled down by heat dissipation, or a cooling, heat dissipation device can be installed to quickly conduct the heat generated during the operation of the light-emitting layer 25 to the outside. The cooling, heat dissipation process can be performed by heat pipes or heat sinks. The material of the metal layer can be one selected from among Ag, Ag alloy, Al, Mo—Al alloy, Cr, and so on.

The tips on the metal layer 24 resulting from an etch process may cause discontinuity of the coating layer of the light-emitting layer 25 and abnormal light emission. Therefore, an insulating material layer 29 is needed to wrap the metal layer 24 of the OLED 20a, as shown in FIG. 2(c), so as to produce a flattening effect, thereby eliminating the discontinuity of the coating layer of the light-emitting layer 25.

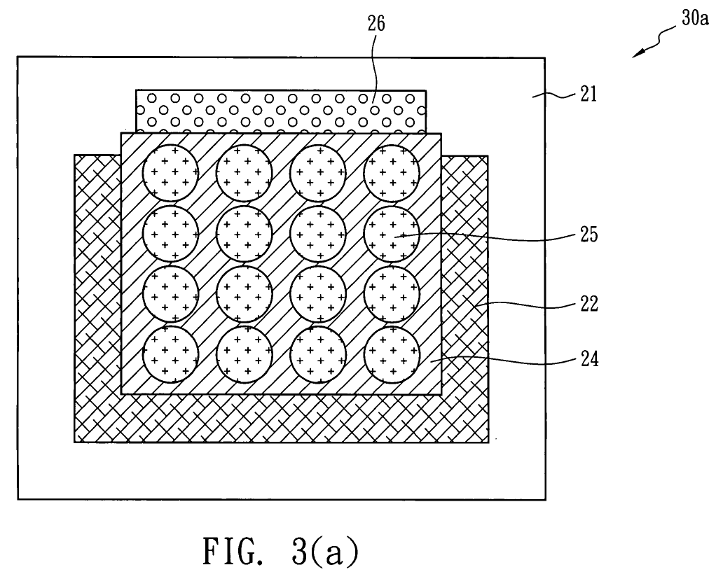

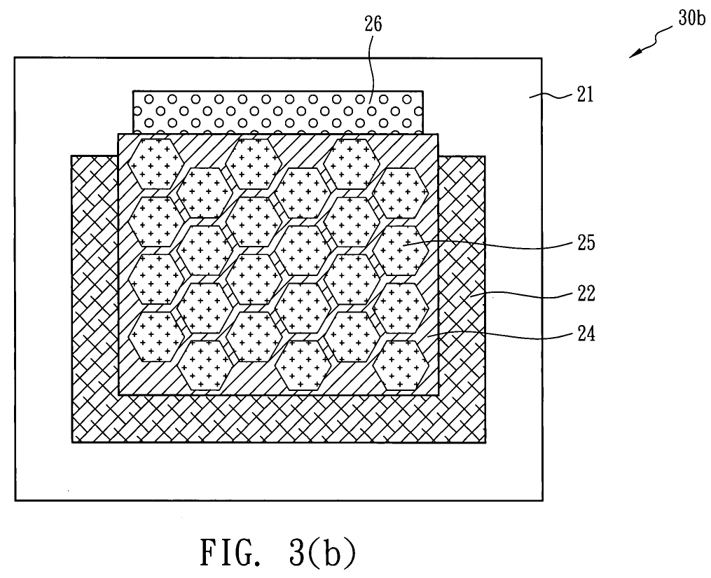

As shown in the schematic top view of FIG. 2(a), the metal layer 24 covers a part of the light-emitting layer 25. The shape of the effective light-emitting areas of the light-emitting layer 25 is not limited to the plurality of rectangles in FIG. 2(a), but can be a plurality of arbitrary polygons. As shown in FIG. 3(a), the shape of the effective light-emitting areas of the light-emitting layer 25 in the OLED 30a is a plurality of circles. As shown in FIG. 3(b), the shape of the effective light-emitting areas of the light-emitting layer 25 in the OLED 30b is a plurality of honeycombs.

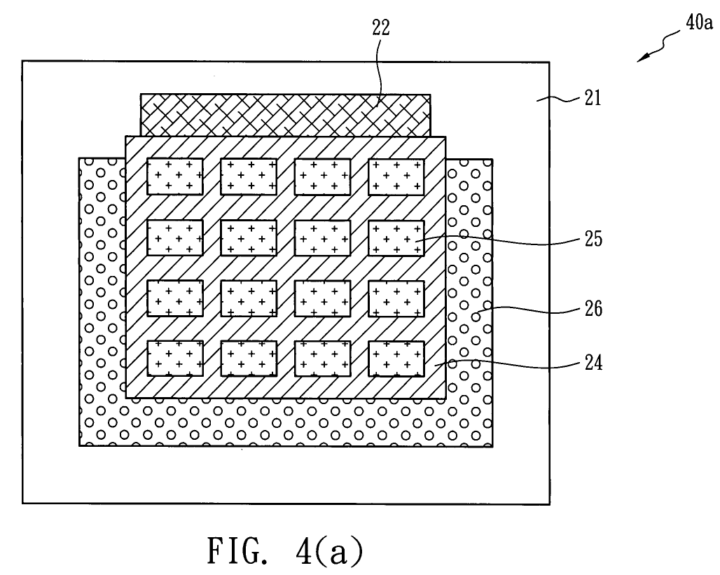

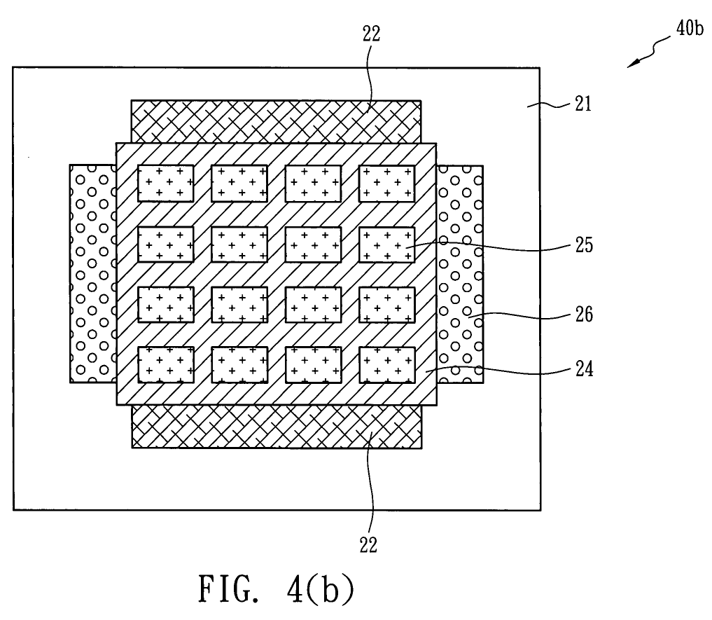

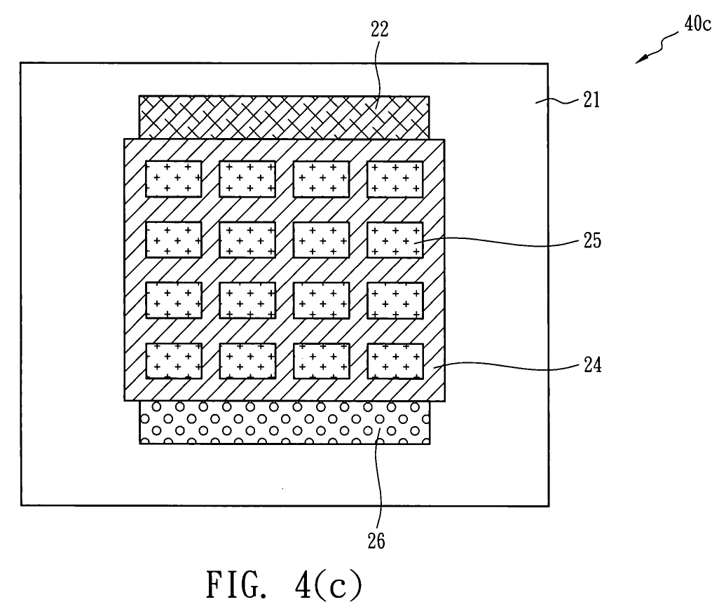

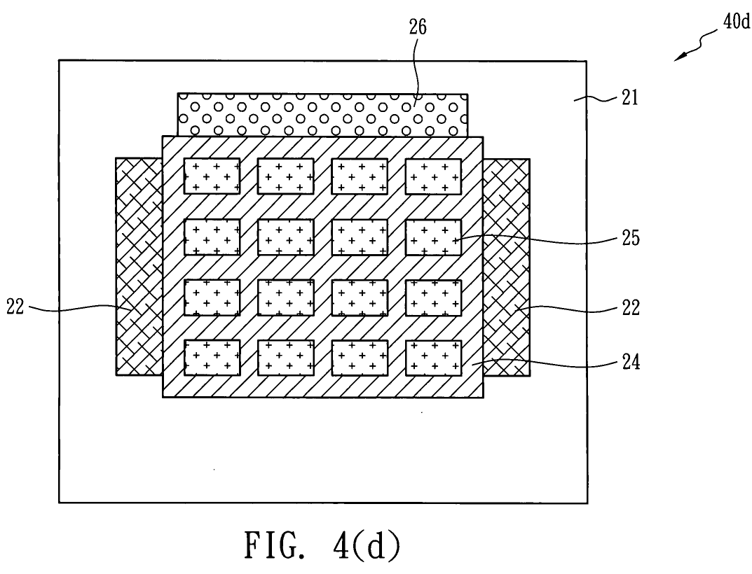

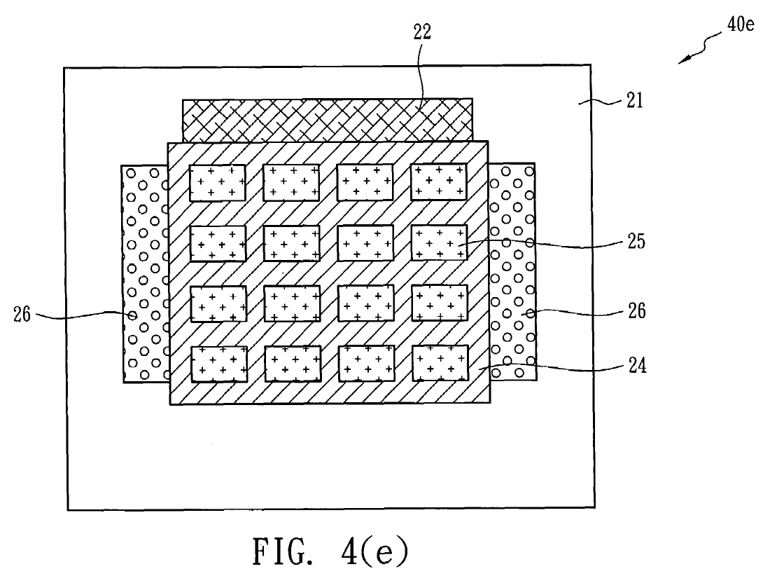

As shown in the schematic top view in FIG. 2(a), the OLED 20 includes an external anode 22 adjacent to three sides and an external cathode 26 at one side. Referring to FIG. 4(a), the OLED 40a includes an external cathode 26 adjacent to three sides and an external anode 22 at one side. Referring to FIG. 4(b), the OLED 40b includes an external cathode 26 at two opposite sides and an external anode 22 at two opposite sides. Referring to FIG. 4(c), the OLED 40c includes an external cathode 26 at one side and an external anode 22 at the opposite side. Referring to FIG. 4(d), the OLED 40d includes an external cathode 26 at one side and an external anode 22 at two opposite sides. Referring to FIG. 4(e), the OLED 40e includes an external cathode 26 at two opposite sides and an external anode 22 at one side. In the present invention, the number and arrangement of the external anode 22 and external cathode 26 are not limited to those, and can be varied as required.

The aforementioned descriptions of the present invention are intended to be illustrative only. Numerous alternative methods may be devised by persons skilled in the art without departing from the scope of the following claims.

What is claimed is:

1. An organic light-emitting device (OLED) with a heat dissipation structure, comprising:
a substrate;
an anode layer formed on the substrate;
a metal layer formed on the anode layer;
a light-emitting layer formed on the anode layer and covering the metal layer;
a cathode layer formed on the light-emitting layer;
at least one external anode connected to the anode layer; and
at least one external cathode connected to the cathode layer;
wherein the metal layer covers a part of the light-emitting layer, and forms a plurality of effective light-emitting areas on the residual light-emitting areas.

2. The OLED with a heat dissipation structure of claim 1, further comprising an insulating layer covering the metal layer.

3. The OLED with a heat dissipation structure of claim 1, wherein the shapes of the effective light-emitting areas are a plurality of arbitrary polygons.

4. The OLED with a heat dissipation structure of claim 1, wherein the shapes of the effective light-emitting areas are a plurality of rectangles.

5. The OLED with a heat dissipation structure of claim 1, wherein the shapes of the effective light-emitting areas are a plurality of circles.

6. The OLED with a heat dissipation structure of claim 3, wherein the shapes of the effective light-emitting areas are a plurality of honeycombs.

7. The OLED with a heat dissipation structure of claim 1, wherein the external anode is disposed on three sides of the light-emitting layer, and the external cathode is disposed on one side of the light-emitting layer.

8. The OLED with a heat dissipation structure of claim 1, wherein the external cathode is disposed on three sides of the light-emitting layer, and the external anode is disposed on one side of the light-emitting layer.

9. The OLED with a heat dissipation structure of claim 1, wherein the external anode is disposed on one side of the light-emitting layer, and the external cathode is disposed on another side of the light-emitting layer.

10. The OLED with a heat dissipation structure of claim 1, wherein the external anode is disposed at two opposite sides of the light-emitting layer, and the external cathode is disposed at the other two opposite sides of the light-emitting layer.

11. The OLED with a heat dissipation structure of claim 1, further comprising a heat dissipation device connected to the external anode and the external cathode.

12. The OLED with a heat dissipation structure of claim 11, wherein the cooling heat dissipation device is a heat pipe.

13. The OLED with a heat dissipation structure of claim 11, wherein the cooling heat dissipation device is a heat sink.

14. The OLED with a heat dissipation structure of claim 1, wherein the material of the metal layer is selected from the group consisting of Ag, Ag alloy, Al, Mo—Al alloy and Cr.
